(19) United States
(12) Patent Application Publication
(10) Pub. No.: US 2009/0321406 A1
(43) Pub. Date: Dec. 31, 2009

(54) FIXING HEATER AND METHOD FOR MANUFACTURING THE SAME

(75) Inventors: Yasuyuki Aritaki, Kyoto (JP); Shinobu Obata, Kyoto (JP); Teruhisa Sako, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD, Kyoto (JP)

(21) Appl. No.: 12/521,106

(22) PCT Filed: Dec. 25, 2007
(86) PCT No.: PCT/JP2007/074788

§ 371 Date: Jun. 24, 2009

(30) Foreign Application Priority Data
Dec. 25, 2006 (JP) 2006-347498

(51) Int. Cl. H05B 3/00; H01C 17/02

(52) U.S. Cl. 219/201; 29/611

(57) ABSTRACT

A fixing heater (A2) includes an insulating substrate (1), a heating resistor (2) formed on the substrate, and a pair of electrodes (4) each of which overlaps a respective one of two ends of the heating resistor. The heating resistor (2) contains Ag—Pd and crystallized glass. Each of the electrodes (4) contains glass of the same composition as the crystallized glass. When the proportion by weight of the crystallized glass in the heating resistor (2) is represented by x, the proportion y by weight of Pd in the Ag—Pd satisfies −0.091x+0.50≦y≦−0.091x+0.57.

### TECHNICAL FIELD

The present invention relates to a fixing heater used in e.g. laser printers to thermally fix toner, which has been transferred to recording paper, to the recording paper. The present invention also relates to a method for making such a fixing heater.

### BACKGROUND ART

Conventionally, various types of fixing heaters (hereinafter simply referred to as “heater”) have been proposed. For instance, Patent Document 1 identified below discloses a heater including a heating resistor formed with a plurality of slits.

Patent Document 1: JP-A-2004-6289

A typical conventional heater is illustrated in FIG. 12 of the present application. The illustrated heater X includes an insulating substrate 91, a heating resistor 92 provided on the substrate, and a pair of electrodes 93. The heating resistor 92 is made of e.g. Ag—Pd and in the form of a strip partially bent on the substrate 91. Each of the electrodes 93 partially overlaps an end of the heating resistor 92. Though not illustrated, the heating resistor 92 is covered with a glass protective film. When electrical power is applied to the heating resistor 92, the heating resistor 92 heats up. In this state, recording paper is pressed against the heater X by a platen roller. As a result, toner is thermally fixed to the recording paper.

In a laser printer incorporating the heater X, to increase the printing speed, the sliding speed of recording paper relative to the heater X needs to be increased. For this purpose, it is necessary to increase the pressing force of the platen roller relative to recording paper. However, when these measures are taken, the load applied to the heating resistor 92 via the glass protective film increases, which may cause part 92a of the heating resistor 92 to be detached from the substrate 91. Further, in the heater X, part 92b of the heating resistor 92, which overlaps the electrode 93, may also be detached. Such detachment can be caused by internal stress remaining in the glass protective film or thermal stress due to repetitive heating and cooling during the use of the heater X.

Moreover, the resistance of the heating resistor made of Ag—Pd depends on the temperature. Generally, the temperature dependency of resistance is expressed by the rate of change of resistance with a temperature change by 1° C., i.e., the temperature coefficient of resistance (TCR). The temperature coefficient of resistance of conventional heaters is about 300 ppm/° C. The higher the temperature coefficient of resistance is, the more difficult it is to keep the heating resistor of the heater at a constant temperature by controlling the current. When the temperature of the heating resistor varies, toner is not properly fixed to recording paper. In recent years, there are demands for the enhancement of printing speed and high fineness of printing, so that a reduction in temperature coefficient of resistance of the heating resistor has been demanded.

### DISCLOSURE OF THE INVENTION

The present invention has been proposed under the circumstances described above. It is, therefore, an object of the present invention to provide a heater which is capable of preventing the detachment of the heating resistor from the substrate or electrode and in which the heating resistor has a low temperature coefficient of resistance.

According to a first aspect of the present invention, there is provided a fixing heater including a substrate, and a heating resistor formed on the substrate and containing a resistive material and crystallized glass. Preferably, the crystallization temperature of the crystallized glass is not higher than 750° C., and the difference between the softening temperature and the crystallization temperature of the crystallized glass is not less than 100° C. The crystallized glass may be either SiO2—B2O3—R or SiO2—B2O3—Al2O3—R, where R is any one of ZnO2, Li2O3 and TiO2. Preferably, the proportion by weight of the crystallized glass in the heating resistor is 3% to 25%.

The fixing heater according to the present invention may further include an electrode formed on the substrate to overlap the heating resistor. Preferably, in this case, the electrode contains glass of the same composition as the glass contained in the heating resistor.

Preferably, the resistive material is Ag—Pd, and the electrode contains Ag. The electrode may further contain Pd.

In the fixing heater of the present invention, when the resistive material is Ag—Pd, the proportion y by weight of Pd in the Ag—Pd may be set to satisfy −0.091x+0.50≦y≦−0.091x+0.57. Herein, x is the proportion by weight of the crystallized glass in the heating resistor, which may be set to the range of 3% to 25%.

According to a second aspect of the present invention, there is provided a fixing heater including a substrate, and a heating resistor formed on the substrate and containing Ag—Pd and glass. The proportion y by weight of Pd in the Ag—Pd is set to satisfy −0.091x+0.50≦y≦−0.091x+0.57, where x is the proportion by weight of the glass in the heating resistor. The glass may be crystallized glass or amorphous glass.

According to a third aspect of the present invention, there is provided a fixing heater including a substrate, a heating resistor formed on the substrate, and an electrode formed on the substrate to overlap the heating resistor. The heating resistor and the electrode contain glass of the same composition. The glass may be crystallized glass or amorphous glass.

According to a fourth aspect of the present invention, there is provided a method for making a fixing heater. The method includes the steps of applying resistor paste containing a resistive material and glass to a substrate, and baking the resistor paste while raising the baking temperature from a temperature that is lower than the softening temperature of the glass to a temperature that is higher than the crystallization temperature of the glass by not less than 100° C.

According to a fifth aspect of the present invention, there is provided a method for making a fixing heater. The method includes the steps of applying resistor paste and conductor paste to a substrate in such a manner as to overlap each other, and baking the resistor paste and the conductor paste collectively to form a heating resistor and an electrode that overlap each other. The resistor paste and the conductor paste contain glass of the same composition.

Other features and advantages of the present invention will become more apparent from the detailed description given below with reference to the accompanying drawings.

### BRIEF DESCRIPTION OF THE DRAWINGS

FIG. 1 is a perspective view showing a fixing heater according to a first embodiment of the present invention.

FIG. 2 is a sectional view taken along lines II-II in FIG. 1.

FIG. 3 is a graph showing the relationship between the temperature coefficient of resistance α and the proportion by weight of Pd.

FIG. 4 is a graph showing the relationship between the proportion ymax, ymin by weight of Pd and the proportion by weight of glass.

FIG. 5 is a perspective view showing a fixing heater according to a second embodiment of the present invention.

FIG. 6 is a sectional view taken along lines VI-VI in FIG. 5.

FIG. 7 is a sectional view taken along lines VII-VII in FIG. 5.

FIG. 8 is a sectional view showing the step of applying conductor paste to a substrate.

FIG. 9 is a sectional view showing the step of applying resistor paste to a substrate.

FIG. 10 is a sectional view showing the step of baking the conductor paste and the resistor paste.

FIG. 11 is a sectional view showing a principal portion of a fixing heater according to a third embodiment of the present invention.

FIG. 12 is a perspective view showing a conventional fixing heater.

### BEST MODE FOR CARRYING OUT THE INVENTION

Preferred embodiments of the present invention will be described below with reference to the accompanying drawings.

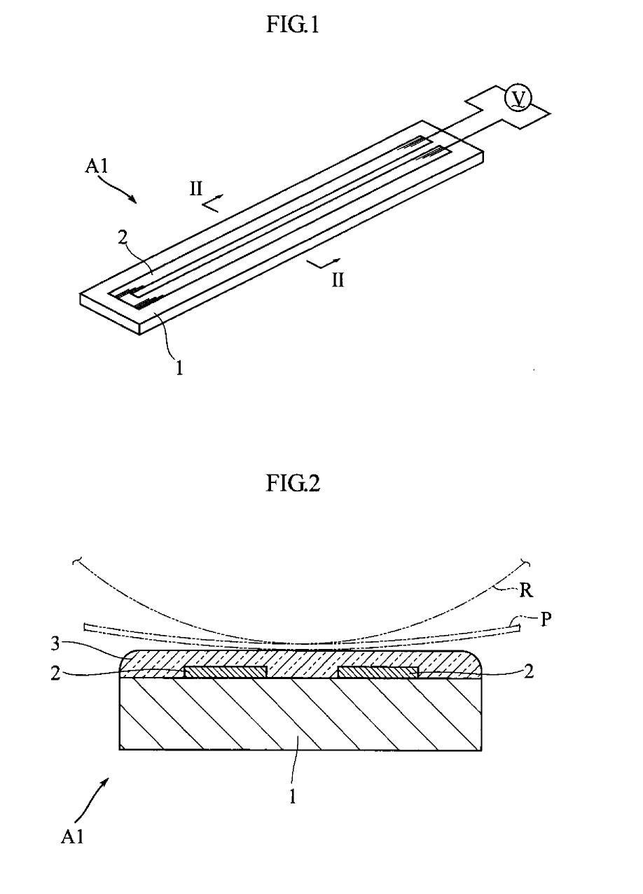

FIGS. 1 and 2 show a heater A1 according to a first embodiment of the present invention. The heater A1 includes a substrate 1, a heating resistor 2 and a protective film 3 (omitted in FIG. 1). The heater A1 is incorporated in e.g. a laser printer to thermally fix toner transferred to recording paper P. The recording paper P is pressed against the heater A1 by a rotating platen roller R for sliding movement relative to the heater A1. The toner transferred to the recording paper P is heated by the heater A1 and fixed to the recording paper P.

The substrate 1 is in the form of an elongated rectangle and made of an insulating material. Examples of the insulating material include AlN and Al₂O₃.

The heating resistor 2 is provided on the substrate 1 and in the form of a strip including two linear portions extending in parallel to each other and a relatively short connecting portion connecting the linear portions to each other. The heating resistor 2 contains a resistive material and crystallized glass. The resistive material is e.g. Ag—Pd. The proportion y by weight of Pd in Ag—Pd is in the range of e.g. about 50% to 60%. Specifically, when the proportion by weight of the crystallized glass in the heating resistor 2 is represented by x, y satisfies −0.091x+0.50≦y≦−0.091x+0.57. Thus, when x is 0.1 (i.e., 10%), y is in the range of 0.49 (49%) to 0.56 (56%). As the glass, it is preferable to use one whose crystallization temperature is not higher than 750° C. Specifically, as the glass, use may be made of SiO₂—B₂O₃—R or SiO₂—B₂O₃—Al₂O₃—R (where R is any one of ZnO₂, Li₂O₃ and TiO₂). In this embodiment, SiO₂—B₂O₃—ZnO₂ is used, which has a softening temperature of about 570° C. and a crystallization temperature of about 730° C. It is preferable that the proportion of the crystallized glass in the heating resistor 2 is in the range of 3% to 25%.

The protective film 3 protects the heating resistor 2. The protective film may be made of crystallized glass or amorphous glass.

A method for making the heater Al will be described below.

First, a substrate material containing AlN is baked at a baking temperature of e.g. 850° C. Thus, a substrate 1 made of AlN is obtained.

Then, resistor paste containing the above-described resistive material and glass is applied to the substrate 1 by e.g. thick film printing. The glass may be contained in the resistor paste as glass frit in the form of particles.

Then, the resistor paste is baked. In this process, the baking temperature is raised gradually from ordinary temperature to e.g. 850° C., which is higher than 730° C., i.e., the crystallization temperature of the glass by more than 100° C., through 570° C., which is the softening temperature of the glass. The temperature of 850° C. is the upper limit which is suitable for obtaining a good heating resistor by baking the resistor paste containing Ag—Pd. The baking temperature is maintained at 850° C. until the resistor paste is baked sufficiently. Thus, the heating resistor 2 is obtained.

Then, glass paste is applied to cover the heating resistor 2. The glass paste is baked at a baking temperature of 810° C., whereby a protective film 3 is formed. In this way, the heater Al is obtained.

The advantages of the heater Al will be described below.

In the baking process to make the heating resistor 2, the glass softens when the baking temperature reaches 570° C., i.e., the softening temperature of the glass contained in the heating resistor 2. Thus, the glass, which was glass frit, changes to an almost liquid state. The glass in the liquid state is readily attracted to the surface of the substrate 1, so that the contact area between the glass and the substrate 1 considerably increases. Particularly, in the above-described glass, the difference between the softening temperature and the crystallization temperature is as large as 160° C. Thus, before the baking temperature raised from the softening temperature reaches the crystallization temperature, the glass is sufficiently attracted to the substrate 1.

When the baking temperature reaches the crystallization temperature of the glass, i.e., 730° C., the crystallization of the glass starts. The crystallization proceeds, with the glass held in contact with the substrate 1 at a large area. The crystallization of the glass continues until the baking temperature reaches the upper limit temperature of 850° C. To properly bake resistor paste containing Ag—Pd, about 850° C. is the upper limit of the baking temperature. However, since the crystallization of the glass starts at a temperature which is lower than this upper limit temperature by more than 100° C., the glass is crystallized sufficiently to become firm. Due to the crystallization which proceeds while keeping a large contact area with the substrate 1, the heating resistor 2 is made sufficiently hard and hence prevented from being detached from the substrate 1.

The inventors of the present invention performed a test to find how the likelihood of detachment of the heating resistor 2 varies depending on the difference between the softening temperature and the crystallization temperature of glass. As a result, when the difference between the softening temperature and the crystallization temperature was 100° C. or 150° C., the heating resistor 2 was not detached even when a force was applied by peeling off an adhesive tape attached to the resistor element 2. However, when the difference between the softening temperature and the crystallization temperature was 50° C., the heating resistor 2 was easily detached by peeling off the adhesive tape. These results indicate that it is suitable to use SiO₂—B₂O₃—R or SiO₂—B₂O₃—Al₂O₃—R (where R is any one of ZnO₂, Li₂O₃ and TiO₂) as the glass, because, in this glass, the crystallization temperature is not higher than 750° C. and the difference between the softening temperature and the crystallization temperature is not less than 100° C.

The firm attachment of the heating resistor 2 to the substrate 1 due to the crystallized glass is established when the proportion of the crystallized glass in the heating resistor 2 is not less than 3%. The crystallized glass, which is an insulator, does not unduly hinder the electrical conduction of the heating resistor 2 when the proportion of the crystallized glass is not more than 25%.

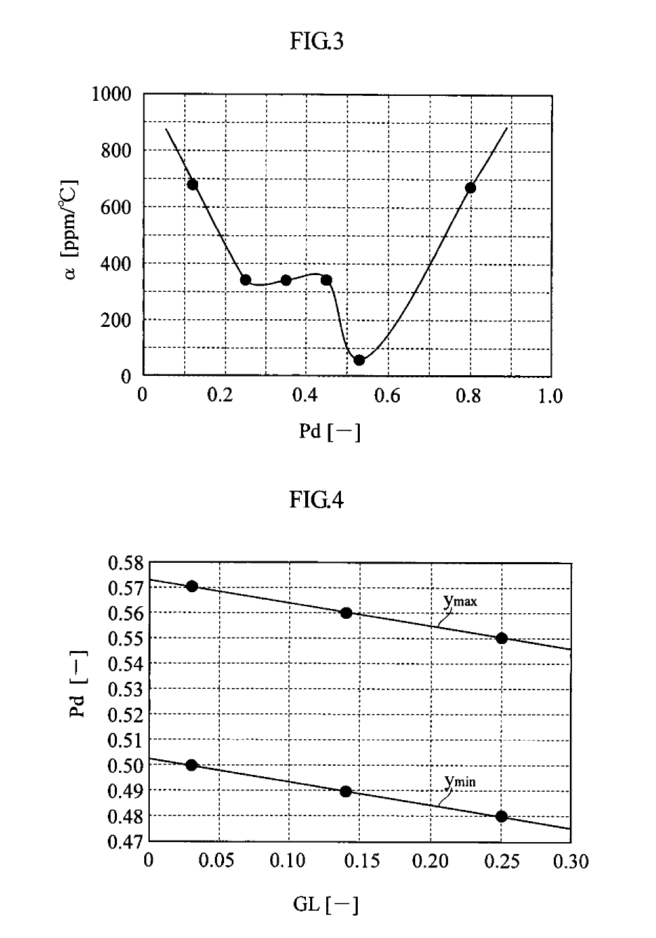

To considerably reduce the temperature coefficient of resistance α, which is about 300 ppm/° C. in a conventional structure, the inventors of the present invention performed a test with respect to the material of the heating resistor 2. FIG. 3 is a graph showing part of the results. The graph shows the relationship between the proportion y by weight of Pd in Ag—Pd and the temperature coefficient of resistance α of the heating resistor 2. The proportion x of the crystallized glass in the heating resistor 2 by weight is kept 10%. As will be understood from the figure, the temperature coefficient of resistance α largely depends on the proportion y by weight of Pd in Ag—Pd.

Generally, when Ag—Pd is employed as the material of the heating resistor 2, the proportion y by weight of Pd is kept relatively low, because Pd is more expensive than Ag. The temperature coefficient of resistance α of conventional heaters is about 300 ppm/° C., and this level of temperature coefficient of resistance is achieved by setting the proportion y by weight of Pd to about 25% to 40%. Generally to reduce the manufacturing cost of the heater, the proportion y of Pd is set to about 25%.

However, in the test performed by the inventors, the proportion y by weight of Pd is changed in a wide range, i.e., to a value (about 80%), which has not been conventionally employed, in order to further reduce the temperature coefficient of resistance α. As a result, it is found that the temperature coefficient of resistance α rapidly reduces when the proportion y exceeds 45%, reaches the minimum value when the proportion y is about 52% to 53%, and then increases as the proportion y increases. That is, the temperature coefficient of resistance α is kept not more than 100 ppm/° C., and more specifically, 80 ppm/° C. when the proportion y of Pd is in the range of 49% to 56%. When the temperature coefficient of resistance α is reduced to this level (not more than ⅓ of the conventional value), the temperature control of the heating resistor 2 is performed more precisely. As a result, the heater Al reliably performs the thermal fixation of toner to the recording paper P, which leads to the achievement of an increase in printing speed of a laser printer and fineness of printing.

Further, the inventors of the present invention found that the range of the proportion y of Pd, which was effective in keeping the resistor element α not more 100 ppm/° C., changed depending on the proportion x by weight of the crystallized glass in the heating resistor 2. That is, the graph of FIG. 3, which indicates the relationship between the proportion y of Pd and the temperature coefficient of resistance α, shifts slightly when the proportion x by weight of the crystallized glass changes. The inventors performed a test with respect to heating resistors 2 of different crystallized glass weight proportions x, i.e., 3%, 14% and 25%. FIG. 4 shows the results of the test. Specifically, the figure shows the maximum value ymax and minimum value ymin of the proportion y by weight of Pd (vertical axis) which are capable of keeping the temperature coefficient of resistance α not more than 100 ppm/° C. As shown in the figure, the proportions ymax and ymin of Pd monotonically reduce as the proportion x by weight of the crystallized glass (horizontal axis) increases. This result indicates that the temperature coefficient of resistance α of the heating resistor 2 is kept not more than 100 ppm/° C. when the proportion y by weight of Pd satisfies −0.091x+0.50≦y≦−0.091x+0.57.

FIGS. 5-7 show a heater A2 according to a second embodiment of the present invention. The heater A2 includes a substrate 1, a heating resistor 2, a protective film 3 and a pair of electrodes 4.

Similarly to the first embodiment, the substrate 1 is in the form of an elongated rectangle and made of an insulating material. Examples of the insulating material include AlN and Al₂O₃.

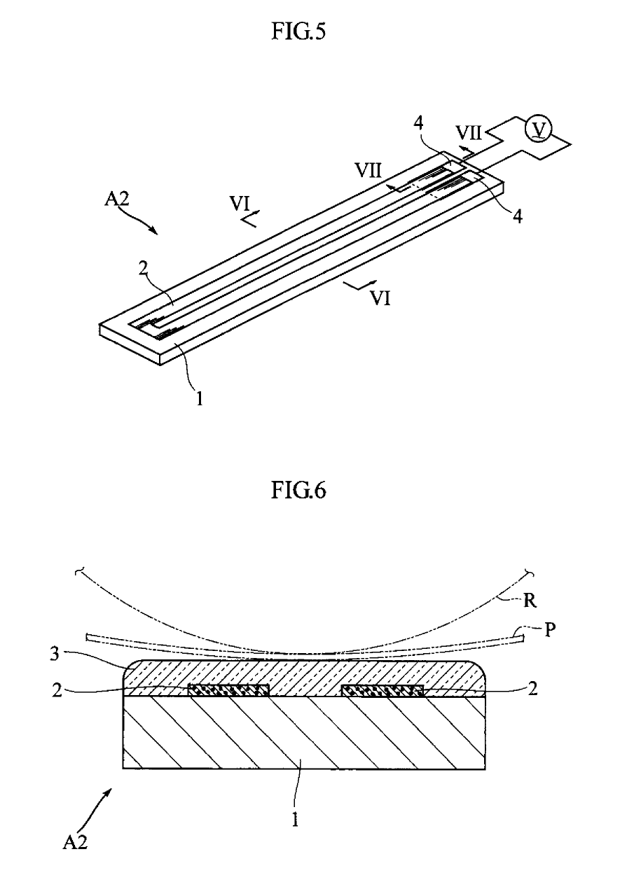

Similarly to the first embodiment, the heating resistor 2 is in the form of a strip formed on the substrate 1. The heating resistor 2 contains a resistive material and crystallized glass. The resistive material is e.g. Ag—Pd. The proportion y by weight of Pd in Ag—Pd is in the range of e.g. about 50% to 60%. Specifically, when the proportion by weight of the crystallized glass in the heating resistor 2 is represented by x, y satisfies −0.091x+0.50≦y≦−0.091x+0.57. Thus, when x is 0.1 (i.e., 10%), y is in the range of 0.49 (49%) to 0.56 (56%). As the glass, it is preferable to use one whose crystallization temperature is not higher than 750° C. Specifically, as the glass, use may be made of SiO₂—B₂O₃—R or SiO₂—B₂O₃—Al₂O₃—R (where R is any one of ZnO₂, Li₂O₃ and TiO₂). In this embodiment, SiO₂—B₂O₃—ZnO₂ is used. It is preferable that the proportion of the crystallized glass in the heating resistor 2 is in the range of 3% to 25%. In FIGS. 6-10, the crystallized glass is schematically illustrated as particles.

The protective film 3 protects the heating resistor 2. The protective film may be made of crystallized glass or amorphous glass.

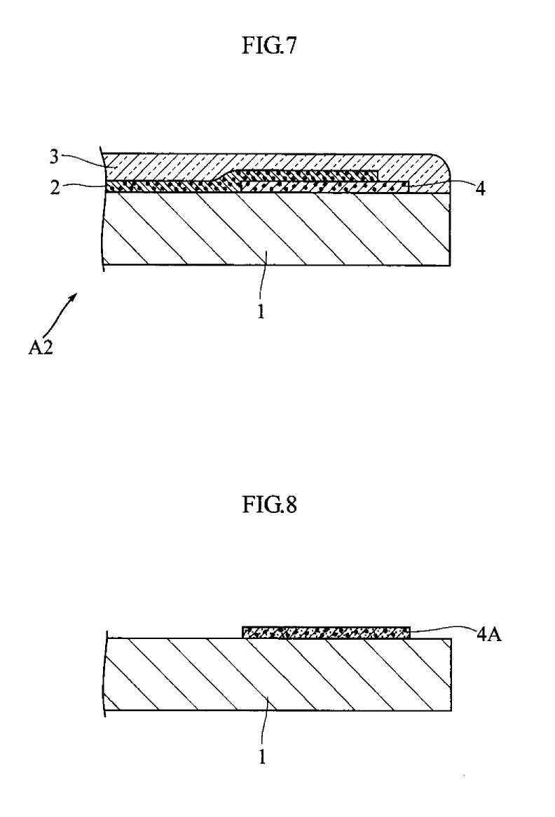

The paired electrodes 4 are for supplying power from e.g. an AC power supply to the heating resistor 2. As shown in FIG. 7, each of the electrodes 4 is formed on the substrate 1 to partially overlap an end of the heating resistor 2. The electrode 4 contains Ag—Pd and crystallized glass. The Ag—Pd contained in the electrode 4 may consist of 97 wt % of Ag and 3 wt % of Pd. It is preferable that the proportion by weight of Pd in the Ag—Pd is about 1% to 5%. The crystallized glass contained in the electrodes 4 has the same composition as that contained in the heating resistor 2 and is SiO₂—B₂O₃—ZnO₂ in this embodiment. The proportion of the crystallized glass in the electrodes 4 is smaller than the proportion of the crystallized glass in the heating resistor 2. In FIGS. 6-10, the crystallized glass is schematically illustrated as particles.

A method for making the heater A2 will be described below with reference to FIGS. 8-10.

First, as shown in FIG. 8, conductor paste 4A containing Ag—Pd as a conductive material and the glass is applied to the substrate 1 by e.g. thick film printing. The Ag—Pd contained in the conductor paste 4A consists of 97 wt % of Ag and 3 wt % of Pd. The glass is SiO₂—B₂O₃−ZnO₂ and accounts for several percent of the conductor paste 4A. The glass may be contained in the conductor paste 4A as glass frit in the form of particles.

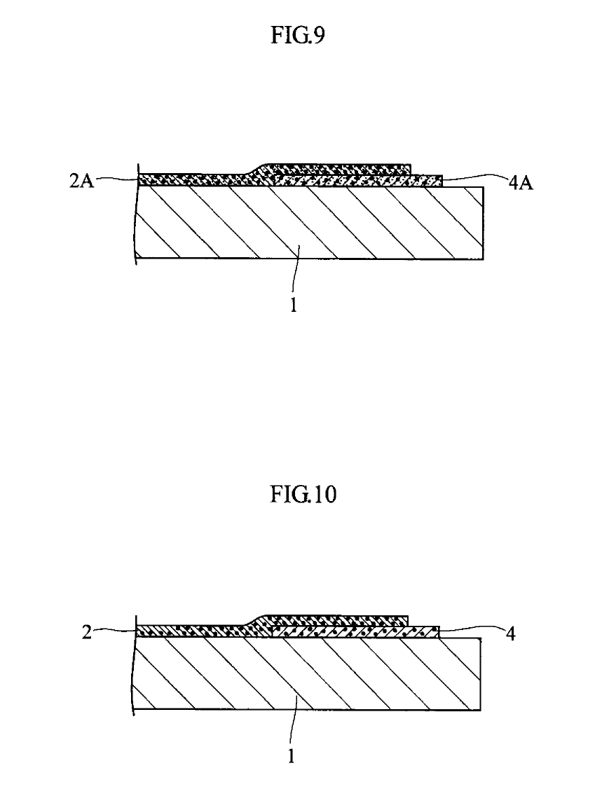

Then, as shown in FIG. 9, resistor paste 2A containing Ag—Pd as a resistive material and the glass is applied by e.g. thick film printing. The resistor paste 2A is applied to cover part of the conductor paste 4A applied before. The proportion by weight of Ag—Pd in the resistor paste 2A is set to the range of 49% to 56%. The glass is SiO₂—B₂O₃—ZnO₂ and accounts for 3% to 25% of the resistor paste 2A. The glass may be contained in the resistor paste 2A as glass frit in the form of particles.

Then, the resistor paste 2A and the conductor paste 4A applied are baked collectively. In this process, the baking temperature is raised gradually from ordinary temperature to e.g. 850° C., which is higher than 730° C., i.e., the crystallization temperature of the glass by more than 100° C., through 570° C., which is the softening temperature of the glass. Then, the baking temperature is maintained at 850° C. until the resistor paste is sufficiently baked. Thus, as shown in FIG. 10, the resistor paste 2 and the electrodes 4, which partially overlap each other, are formed.

Then, glass paste is applied in such a manner as to cover e.g. the heating resistor 2. The glass paste is baked at a baking temperature of 810° C., whereby a protective film 3 is formed. In this way, the heater A2 is obtained.

The advantages of the heater A2 will be described below.

According to this embodiment, the heating resistor 2 and the electrodes 4 contain crystallized glass of the same composition. The crystallized glass in the heating resistor and that in the electrodes, which have the same composition, readily bond to each other in e.g. the baking process. Thus, the bond between the heating resistor 2 and the electrodes 4 is enhanced, so that the separation of the heating resistor 2 and the electrode 4 is prevented.

Further, both of the heating resistor 2 and the electrodes 4 contain Ag and Pd. Since both of the heating resistor 3 and the electrodes 4 contain a high proportion of Ag, these elements closely attract each other. Although the proportion by weight of Pd in Ag—Pd has a relatively small value of about 3% in the electrodes 4, the Pd strongly bonds to the Pd contained in the heating resistor 2. This also enhances the bond between the heating resistor 2 and the electrodes 4.

In making the heater A2, the resistor paste 2A and the conductor paste 4A are baked collectively. In the baking process, the glass in the resistor paste 2A and the conductor paste 4A tends to sink due to gravity. Thus, when a method is employed in which the resistor paste 2A is applied after the conductor paste 4A is baked unlike this embodiment, the bond between the heating resistor 2 and the electrodes 4 cannot be enhanced considerably, because the glass is present in only small proportion in the portion of the electrodes 4 which comes into contact with the resistor paste 2A. In contrast, in the method in which the resistor paste 2A is applied on the conductor paste 4A before baking, the proportion of the glass is not reduced in the portion of the conductor paste 4A which comes into contact with the resistor paste 2A. Thus, baking is performed, with the glass contained in the conductor paste 4A and the glass contained in the resistor paste 2A held in close contact with each other. This is suitable for enhancing the bond between the heating resistor 2 and the electrodes 4.

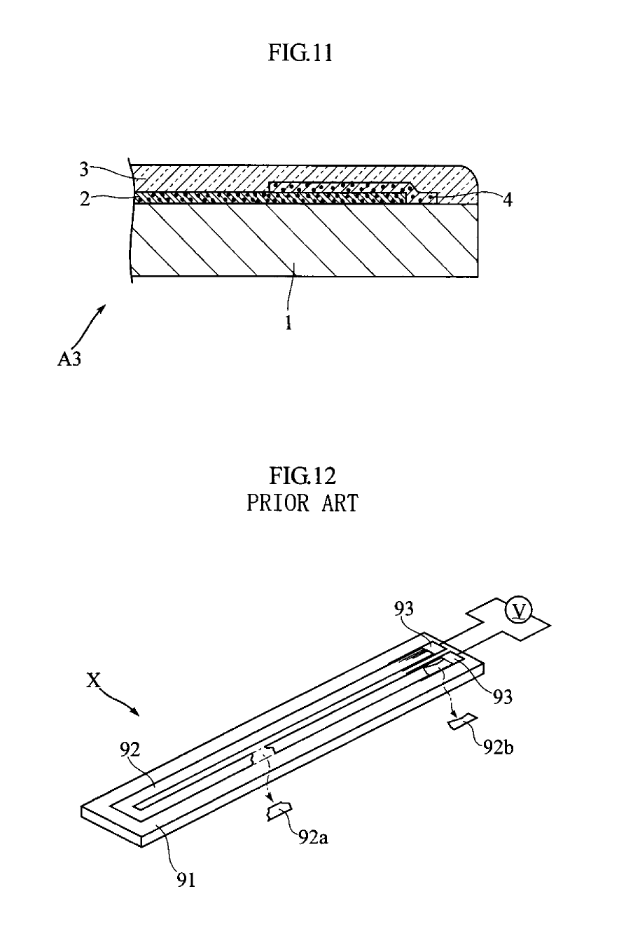

FIG. 11 is a sectional view showing a principal portion of a heater A3 according to a third embodiment of the present invention. The structure of the heater A3 illustrated in the figure is basically the same as that of the heater A2. In this embodiment, however, the heating resistor 2 and the electrode 4 are laminated in the opposite order from that of the second embodiment. That is, the heating resistor 2 is formed on the substrate 1, and the electrode 4 is formed on the heating resistor 2 to partially overlap the heating resistor 2. Similarly to the second embodiment, in a method for making the heater A3, the resistor paste 2A and the conductor paste 4A are baked collectively.

In the third embodiment again, the bond between the heating resistor 2 and the electrode 4 is enhanced. Further, since the electrode 4 does not intervene between the heating resistor 2 and the substrate 1, the heating resistor 2 can be formed to have a flat shape extending along the surface of the substrate 1. This is suitable for preventing the resistance of the heating resistor 2 from varying. It is only necessary that the glass contained in the heating resistor and the glass contained in the electrodes 4 have the same composition. Thus, instead of the above-described crystallized glass, other kind of crystallized glass or amorphous glass may be used.

1. A fixing heater comprising:
a substrate; and
a heating resistor formed on the substrate and containing a resistive material and crystallized glass.

2. The fixing heater according to claim 1, wherein crystallization temperature of the crystallized glass is not higher than 750° C.

3. The fixing heater according to claim 2, wherein difference between softening temperature and the crystallization temperature of the crystallized glass is not less than 100° C.

4. The fixing heater according to claim 1, wherein the crystallized glass is either SiO₂—B₂O₃—R or SiO₂—B₂O₃—Al₂O₃—R, where R is one of ZnO₂, Li₂O₃ and TiO₂.

5. The fixing heater according to claim 1, wherein proportion by weight of the crystallized glass in the heating resistor is 3% to 25%.

6. The fixing heater according to claim 1, further comprising an electrode formed on the substrate to overlap the heating resistor, wherein the electrode contains glass of the same composition as the glass contained in the heating resistor.

7. The fixing heater according to claim 6, wherein the resistive material is Ag—Pd, and the electrode contains Ag.

8. The fixing heater according to claim 7, wherein the electrode further contains Pd.

9. The fixing heater according to claim 1, wherein the resistive material is Ag—Pd, and proportion y by weight of Pd in the Ag—Pd satisfies −0.091x+0.50≦y≦−0.091x+0.57, where x is proportion by weight of the crystallized glass in the heating resistor.

10. The fixing heater according to claim 9, wherein proportion by weight of the crystallized glass in the heating resistor is 3% to 25%.

11. A fixing heater comprising:
a substrate; and
a heating resistor formed on the substrate and containing Ag—Pd and glass;
wherein proportion y by weight of Pd in the Ag—Pd satisfies −0.091x+0.50≦y≦−0.091x+0.57, where x is proportion by weight of the glass in the heating resistor.

12. A fixing heater comprising:
a substrate;
a heating resistor formed on the substrate; and
an electrode formed on the substrate to overlap the heating resistor;
wherein the heating resistor and the electrode contain glass of a same composition.

13. A method for making a fixing heater, the method comprising the steps of:
applying resistor paste containing a resistive material and glass to a substrate; and
baking the resistor paste while raising baking temperature from a temperature that is lower than softening temperature of the glass to a temperature that is higher than crystallization temperature of the glass by not less than 100° C.

14. A method for making a fixing heater, the method comprising the steps of:
applying resistor paste and conductor paste to a substrate in such a manner as to overlap each other; and
baking the resistor paste and the conductor paste collectively to form a heating resistor and an electrode that overlap each other;
wherein the resistor paste and the conductor paste contain glass of a same composition.
